(19) United States
(12) Patent Application Publication
(10) Pub. No.: US 2016/0144465 A1
(43) Pub. Date: May 26, 2016

(54) REPAIR OR REMANUFACTURE OF COMBUSTOR LINER PANELS WITH AN OXIDATION RESISTANT BRAZE

(71) Applicant: UNITED TECHNOLOGIES CORPORATION, Hartford, CT (US)

(72) Inventors: Steven Ivory, Ashford, CT (US); Michael L. Miller, Euless, TX (US); Michael J. Minor, Arlington, TX (US); Paul M. Pellet, Arlington, TX (US)

(21) Appl. No.: 14/903,014

(22) PCT Filed: Jul. 8, 2014
(86) PCT No.: PCT/US2014/045769

§ 371 Date: Jan. 5, 2016

Related U.S. Application Data
(60) Provisional application No. 61/845,681, filed on Jul. 12, 2013.

(51) Int. Cl. B23P 6/00; B23K 1/00; F23R 3/00; B23K 35/30; B23K 35/02; C22C 19/05; B23K 1/008; B23K 1/19

(52) U.S. Cl. CPC B23P 6/007; B23K 1/008; B23K 1/0018; B23K 1/19; B23K 35/304; B23K 35/025; C22C 19/057; C22C 19/056; C22C 19/055; F23R 3/002; B23K 2203/08

(57) ABSTRACT

A method to fill a gap in a liner panel according to one disclosed non-limiting embodiment of the present disclosure includes: applying a nickel braze alloy composition onto a gap in a liner panel; subjecting the nickel braze alloy composition to a melt cycle; and subjecting the nickel braze alloy composition to a diffusion cycle after the melt cycle.

### CROSS-REFERENCE TO RELATED APPLICATION

This application claims priority to U.S. Provisional Patent Application No. 61/845,681 filed Jul. 12, 2013, which is hereby incorporated herein by reference in its entirety.

### BACKGROUND

The present disclosure relates generally to methods and apparatuses for use of an oxidation resistant braze repair or remanufacture.

Gas turbine engines, such as those that power modern commercial and military aircraft, generally include a compressor section to pressurize an airflow, a combustor section to burn a hydrocarbon fuel in the presence of the pressurized air, and a turbine section to extract energy from the resultant combustion gases.

The combustor section generally includes radially spaced inner and outer liner panels that define an annular combustion chamber therebetween. Arrays of circumferentially distributed combustion air holes penetrate multiple axial locations along each liner to radially admit the pressurized air into the combustion chamber. A plurality of circumferentially distributed fuel nozzles project into a forward section of the combustion chamber through a respective fuel nozzle swirler to supply the fuel to be mixed with the pressurized air.

Aerospace components such as combustor liner panels are subject to damage via Thermo-Mechanical Fatigue (TMF) cracking and oxidation as a result of direct exposure to the severe combustion environment during operation in a gas turbine engine. While strip and recoat repairs exist, there are currently no repairs available to address cracking and erosion, regardless of the severity, in liner wall panels.

### SUMMARY

A method to fill a gap in a liner panel for a gas turbine engine combustor is provided according to one disclosed non-limiting embodiment of the present disclosure. This method includes: applying a nickel braze alloy composition onto a gap in a liner panel; subjecting the nickel braze alloy composition to a melt cycle; and subjecting the nickel braze alloy composition to a diffusion cycle after the melt cycle.

In a further embodiment of the present disclosure, the method includes subjecting the nickel braze alloy composition to the melt cycle within a vacuum furnace.

In a further embodiment of any of the foregoing embodiments of the present disclosure, the method includes subjecting the nickel braze alloy composition to the melt cycle at a temperature above the melting point of the nickel braze alloy composition.

In a further embodiment of any of the foregoing embodiments of the present disclosure, the method includes subjecting the nickel braze alloy composition to the melt cycle for about ten to about twenty minutes.

In a further embodiment of any of the foregoing embodiments of the present disclosure, the method includes subjecting the nickel braze alloy composition to the melt cycle at about 2240° F. (1227° C.) for ten-twenty (10-20) minutes at 0.0005 Torr. or lower.

In a further embodiment of any of the foregoing embodiments of the present disclosure, the method includes subjecting the nickel braze alloy composition to the melt cycle within a vacuum furnace.

In a further embodiment of any of the foregoing embodiments of the present disclosure, the method includes subjecting the nickel braze alloy composition to the diffusion cycle at 2200° F. (1204° C.) for ten (10) hours at 1500-2500 micron (1.5-2.5 Torr) dynamic partial pressure of Argon.

In a further embodiment of any of the foregoing embodiments of the present disclosure, the method includes: subjecting the nickel braze alloy composition to the melt cycle at about 2240° F. (1227° C.) for ten-twenty (10-20) minutes at 0.0005 Torr. or lower; and subjecting the nickel braze alloy composition to the diffusion cycle at 2200° F. (1204° C.) for ten (10) hours at 1500-2500 micron (1.5-2.5 Torr) dynamic partial pressure of Argon.

In a further embodiment of any of the foregoing embodiments of the present disclosure, the method includes subjecting the nickel braze alloy composition to a solution heat treated and cool cycle at a minimum average rate of 35 F (2C) per minute to 1600 F (871 C).

In a further embodiment of any of the foregoing embodiments of the present disclosure, the method includes using an Oxidation Resistant Braze (ORB) composition as the nickel braze alloy composition.

A method to fill a gap in a liner panel for a gas turbine engine combustor is provided according to another disclosed non-limiting embodiment of the present disclosure. This method includes: applying an Oxidation Resistant Braze (ORB) composition onto a gap in a liner panel; subjecting the Oxidation Resistant Braze (ORB) composition to a melt cycle; and subjecting the Oxidation Resistant Braze (ORB) composition to a diffusion cycle after the melt cycle.

In a further embodiment of any of the foregoing embodiments of the present disclosure, the method includes subjecting the nickel braze alloy composition to the melt cycle at about 2240° F. (1227° C.) for ten-twenty (10-20) minutes at 0.0005 Torr. or lower.

In a further embodiment of any of the foregoing embodiments of the present disclosure, the method includes subjecting the nickel braze alloy composition to the diffusion cycle at 2200° F. (1204° C.) for ten (10) hours at 1500-2500 micron (1.5-2.5 Torr) dynamic partial pressure.

In a further embodiment of any of the foregoing embodiments of the present disclosure, the method includes subjecting the nickel braze alloy composition to a solution heat treated and cool cycle at a minimum average rate of 35° F. (2° C.) per minute to 1600° F. (871° C.).

In a further embodiment of any of the foregoing embodiments of the present disclosure, the method includes preparing an area in the vicinity of the gap by removing oxidation byproducts prior to applying the Oxidation Resistant Braze (ORB) composition.

A gas turbine engine is provided according to another disclosed non-limiting embodiment of the present disclosure. This gas turbine engine includes a liner panel with a gap filled with an Oxidation Resistant Braze (ORB) composition.

In a further embodiment of any of the foregoing embodiments of the present disclosure, the gap does not exceed a width of 0.010″ (0.25 mm; 10 mils) with a surface erosion of less than about 0.04″ (1 mm; 40 mil)

In a further embodiment of any of the foregoing embodiments of the present disclosure, means is included for melting and solution heat treating the Oxidation Resistant Braze (ORB) composition to form an alloy with a greater melting temperature than the Oxidation Resistant Braze (ORB) within the gap.

In a further embodiment of any of the foregoing embodiments of the present disclosure, the Oxidation Resistant Braze (ORB) composition has superior oxidation life than PWA 1455.

In a further embodiment of any of the foregoing embodiments of the present disclosure, the Oxidation Resistant Braze (ORB) composition has a superior oxidation life capability over PWA 1484.

The foregoing features and elements may be combined in various combinations without exclusivity, unless expressly indicated otherwise. These features and elements as well as the operation of the invention will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic cross-section of a gas turbine engine;

FIG. 2 is a partial sectional view of an annular combustor with liner panels that may be used with the gas turbine engine shown in FIG. 1;

FIG. 3 is schematic block diagram of a method to repair the aerospace component; and

FIG. 4 is an expanded cross-sectional view of a gap repair according to the method disclosed in FIG. 3 prior to a blending operation.

### DETAILED DESCRIPTION

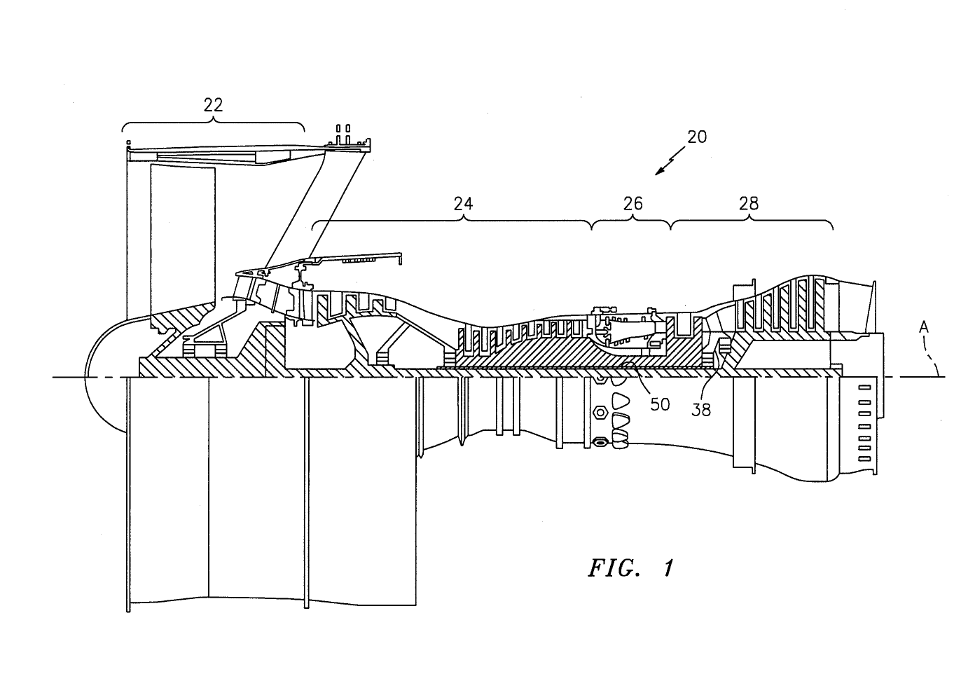

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flowpath while the compressor section 24 drives air along a core flowpath for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines such as a three-spool (plus fan) engine wherein an intermediate spool includes an intermediate pressure compressor (IPC) between a low pressure compressor (LPC) and a high pressure compressor (HPC) and an intermediate pressure turbine (IPT) between a high pressure turbine (HPT) and a low pressure turbine (LPT) or a single spool turbine comprising only a compressor, a combustor and a turbine with a single spool connecting the turbine to the compressor via either a direct drive or a geared architecture.

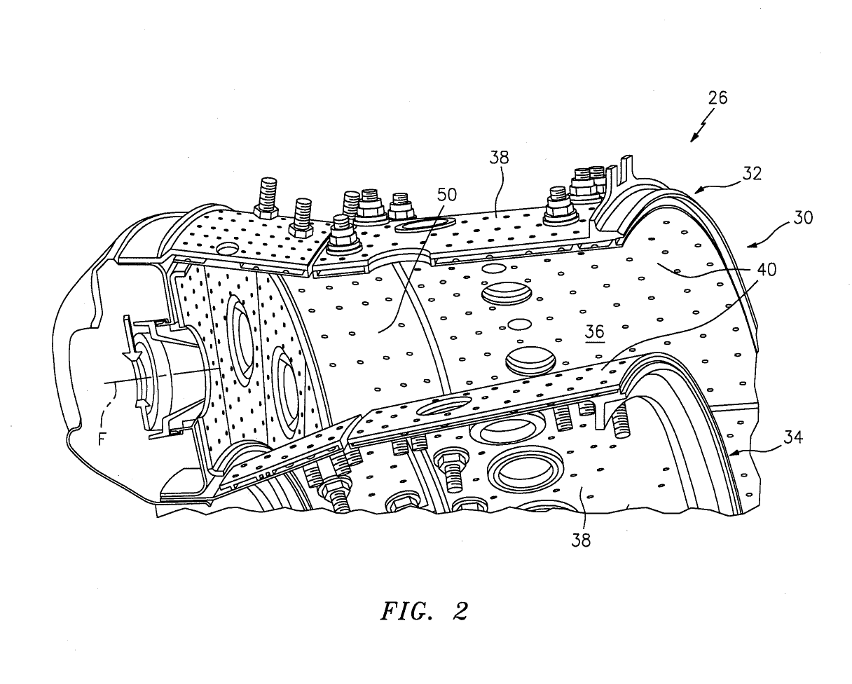

With reference to FIG. 2, the combustor section 26 generally includes a combustor 30 with a combustor outer wall 32 and a combustor inner wall 34 to define a combustion chamber 36 therebetween. The chamber 36 is generally annular in shape. Each wall 32, 34 generally includes a respective support shell 38 that supports one or more respective liner panels 40. The liner panels 40 define a liner array that may be generally annular in shape to sheath the combustion chamber 36. Each of the liner panels 40 may be generally rectilinear and manufactured of, for example, a nickel based super alloy.

The liner panels 40 may be subject to damage via Thermo-Mechanical Fatigue (TMF) cracking and/or oxidation as a result of direct exposure to the severe combustion environment during operation of the gas turbine engine 20. Such TMF damage is represented schematically as a gap 50 to include but not be limited to a crack, void, worn surface or other defect. The gap 50 of the subject repair method 100, however, must not exceed a width of 0.010″ (0.25 mm; 10 mils) with surface erosion of less than about 0.04″ (1 mm; 40 mil).

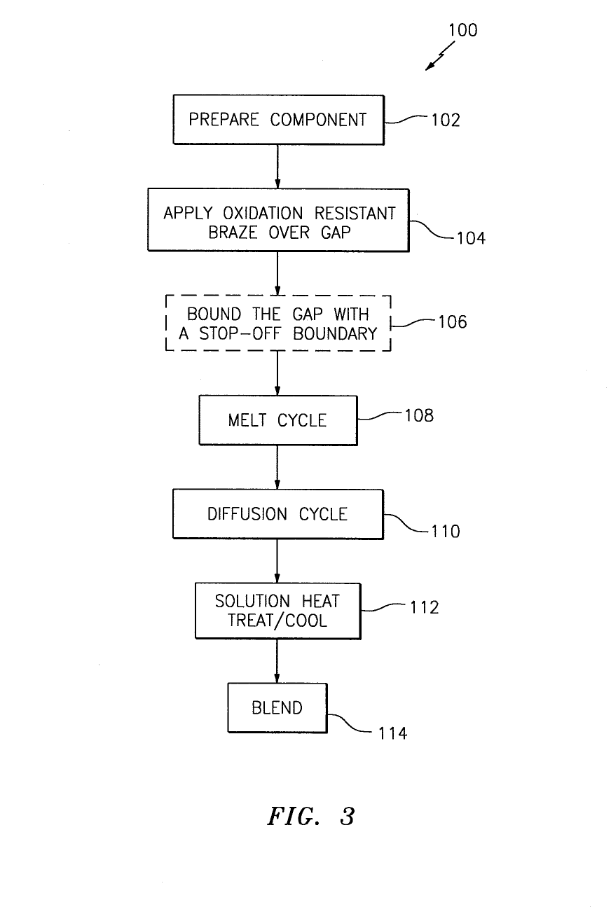

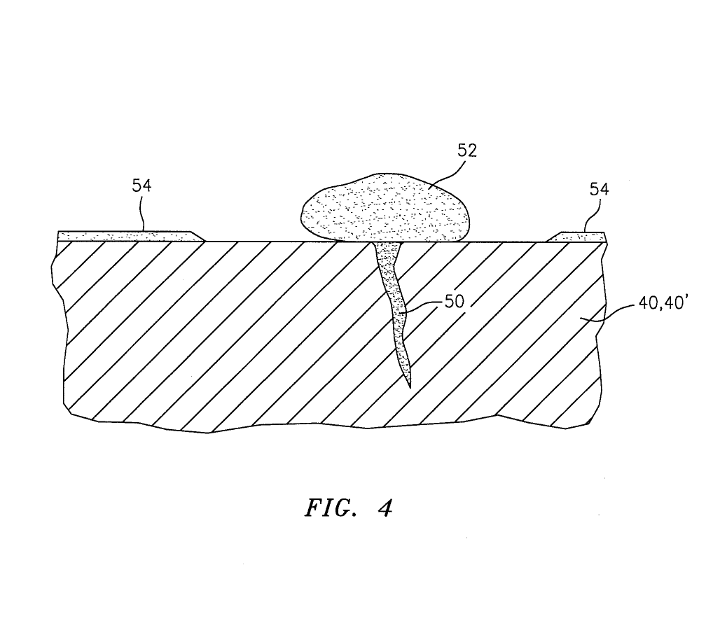

With reference to FIGS. 3 and 4, one disclosed non-limiting embodiment of a repair method 100 initially includes preparation of the liner panel 40 (step 102) such as by degreasing, fluoride-ion cleaning, grit blast, hydrogen furnace clean, vacuum clean and/or others to remove combustion gas formed oxides from the gap 50. It should be appreciated that alternative or additional cleaning and preparation steps to facilitate the method may alternatively be performed.

A nickel braze alloy composition 52 such as an Oxidation Resistant Braze (ORB) composition is then applied to the liner panel 40 over the gap 50 (step 104; FIG. 4). The nickel braze alloy composition 52 is compatible with the nickel based super alloy that forms the linear panels 40. In one aspect, the linear panels 40 are formed of a nickel based super alloy known by the industry specification as a PWA 1455 base alloy. Examples of an Oxidation Resistant Braze (ORB) composition are available under the trademark TURBOFIX.

The nickel braze alloy composition 52, in one disclosed non-limiting embodiment, includes a combination of: base power alloy; alloy powder with a melting point depressant such as boron; and a braze binder such as an organic vehicle like cellulose. For example, the nickel braze alloy composition 52 may include 50-80% base power alloy and 10% braze binder with the remainder as an alloy powder with a melting point depressant. Various other combinations and ingredients may alternatively be utilized.

More specifically, an example nickel braze alloy composition includes a blend of a first nickel alloy and a second nickel alloy. The first nickel alloy includes about 4.75 wt %-10.5 wt % of chromium, about 5.5 wt %-6.7 wt % of aluminum, up to about 13 wt % cobalt, about 3.75 wt %-9.0 wt % of tantalum, about 1.3 wt %-2.25 wt % of molybdenum, about 3.0 wt %-6.8 wt % of tungsten, about 2.6 wt %-3.25 wt % of rhenium, up to about 0.02 wt % of boron, about 0.05 wt %-2.0 wt % of hafnium, up to about 0.14 wt % of carbon, up to about 0.35 wt % of zirconium, and a balance of nickel. The second nickel alloy includes about 21.25 wt %-22.75 wt % of chromium, about 5.7 wt %-6.3 wt % of aluminum, about 11.5 wt %-12.5 wt % of cobalt, about 5.7 wt %-6.3 wt % of silicon, boron in an amount no greater than 1.0 wt %, and a balance of nickel.

In another aspect, a nickel braze alloy composition includes about 20 wt %-80 wt % of a first nickel alloy and about 20 wt %-80 wt % of a second nickel alloy. The second nickel alloy may have a lower melting temperature than the first nickel alloy. The first nickel alloy includes up to about 0.02 wt % of boron, and the second nickel alloy includes boron in an amount no greater than 1.0 wt %.

In another aspect, a nickel braze alloy composition includes a blend of a first nickel alloy and a second, different nickel alloy. The blend includes a combined composition having about 8 wt %-20.3 wt % of chromium 1, about 5.5 wt %-6.7 wt % of aluminum, about 2.3 wt %-12.9 wt % of cobalt, about 0.7 wt %-7.2 wt % of tantalum, about 0.25 wt %-1.8 wt % of molybdenum, about 0.6 wt %-5.5 wt % of tungsten, up to 2.6 wt % of rhenium, about 1.1 wt %-5.1 wt % of silicon, boron in an amount no greater than 0.8 wt %, hafnium in an amount no greater than 1.6 wt %, up to about 0.12 wt % of carbon, up to about 0.3 wt % of zirconium, and a balance of nickel.

The nickel braze alloy composition 52 may be applied onto the gap 50 as a relatively thin bead with, for example, a surgical syringe or other precision applicator. That is, the nickel braze alloy composition 52 is essentially a slurry that may be applied as an elongated bead of about 0.03-0.06 inches in diameter (0.8-1.5 mm) Alternatively, the nickel braze alloy composition 52 may be applied as a paint, paste or preform, either green or pre-sintered.

A stop-off boundary 54 (see FIG. 4) may be optionally applied to bound the gap 50 (step 106). The stop-off boundary may be an oxide based composition or other material.

The liner panel 40 is then placed into a vacuum furnace for a melt cycle (step 108). The melt cycle in one disclosed non-limiting embodiment is at 2240° F. (1227° C.) for ten-twenty (10-20) minutes at 0.0005 Torr. or lower.

The liner panel 40 is then placed into a vacuum furnace for a diffusion heat treat cycle (step 110). The diffusion cycle in one disclosed non-limiting embodiment is at 2200° F. (1204° C.) for ten (10) hours at 1500-2500 micron (1.5-2.5 Torr) dynamic partial pressure of Argon to mitigate chromium evaporation and subsequent depletion from the base alloy of the repair component.

The liner panel 40 is then solution heat treated and cooled (step 112). The solution heat treated and cooled cycle in one disclosed non-limiting embodiment is at a minimum average rate of 35° F. (2° C.) per minute to 1600° F. (871° C.). The nickel braze alloy composition 52 thereafter may have a higher melting point after heat treatment than in the initial braze form.

Finally, the nickel braze alloy composition 52 may be blended into the surface of the liner panel 40 (step 114). The blend may be performed by hand or by machine operation.

Oxidation testing of liner panels with the nickel braze alloy composition 52 and process disclosed herein have demonstrated that the nickel braze alloy composition 52 has approximately 32% superior oxidation life capability over PWA 1484 and as PWA 1484 has superior oxidation life to PWA 1455, the nickel braze alloy composition 52 also has superior oxidation life to PWA 1455. Repairs that employ embodiments of that disclosed herein therefore may reduce repair time and cost, and simultaneously may improve repair quality.

The use of the terms “a” and “an” and “the” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. It should be appreciated that relative positional terms such as “forward,” “aft,” “upper,” “lower,” “above,” “below,” and the like are with reference to the normal operational attitude of the vehicle and should not be considered otherwise limiting.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A method to fill a gap in a liner panel for a gas turbine engine combustor, the method comprising:
applying a nickel braze alloy composition onto a gap in a liner panel;
subjecting the nickel braze alloy composition to a melt cycle; and
subjecting the nickel braze alloy composition to a diffusion cycle after the melt cycle.

2. The method as recited in claim 1, further comprising subjecting the nickel braze alloy composition to the melt cycle within a vacuum furnace.

3. The method as recited in claim 2, further comprising subjecting the nickel braze alloy composition to the melt cycle at a temperature above the melting point of the nickel braze alloy composition.

4. The method as recited in claim 2, further comprising subjecting the nickel braze alloy composition to the melt cycle for about ten to about twenty minutes.

5. The method as recited in claim 2, further comprising subjecting the nickel braze alloy composition to the melt cycle at about 2240° F. (1227° C.) for ten-twenty (10-20) minutes at 0.0005 Torr. or lower.

6. The method as recited in claim 1, further comprising subjecting the nickel braze alloy composition to the melt cycle within a vacuum furnace.

7. The method as recited in claim 6, further comprising subjecting the nickel braze alloy composition to the diffusion cycle at 2200° F. (1204° C.) for ten (10) hours at 1500-2500 micron (1.5-2.5 Torr) dynamic partial pressure of Argon.

8. The method as recited in claim 2, further comprising:
subjecting the nickel braze alloy composition to the melt cycle at about 2240° F. (1227° C.) for ten-twenty (10-20) minutes at 0.0005 Torr. or lower; and
subjecting the nickel braze alloy composition to the diffusion cycle at 2200° F. (1204° C.) for ten (10) hours at 1500-2500 micron (1.5-2.5 Torr) dynamic partial pressure of Argon.

9. The method as recited in claim 8, further comprising subjecting the nickel braze alloy composition to a solution heat treated and cool cycle at a minimum average rate of 35° F. (2° C.) per minute to 1600° F. (871° C.).

10. The method as recited in claim 1, further comprising using an Oxidation Resistant Braze (ORB) composition as the nickel braze alloy composition.

11. A method to fill a gap in a liner panel for a gas turbine engine combustor, the method comprising:
applying an Oxidation Resistant Braze (ORB) composition onto a gap in a liner panel; subjecting the Oxidation Resistant Braze (ORB) composition to a melt cycle; and
subjecting the Oxidation Resistant Braze (ORB) composition to a diffusion cycle after the melt cycle.

12. The method as recited in claim 11, further comprising subjecting the nickel braze alloy composition to the melt cycle at about 2240° F. (1227° C.) for ten-twenty (10-20) minutes at 0.0005 Torr. or lower.

13. The method as recited in claim 11, further comprising subjecting the nickel braze alloy composition to the melt cycle at 2200° F. (1204° C.) for ten (10) hours at 1500-2500 micron (1.5-2.5 Torr) dynamic partial pressure of Argon.

14. The method as recited in claim 11, further comprising subjecting the nickel braze alloy composition to a solution heat treated and cool cycle at a minimum average rate of 35° F. (2° C.) per minute to 1600° F. (871° C.).

15. The method as recited in claim 11, further comprising preparing an area in the vicinity of the gap by removing oxidation byproducts prior to applying the Oxidation Resistant Braze (ORB) composition.

16. A gas turbine engine component, comprising:
a liner panel with a gap filled with an Oxidation Resistant Braze (ORB) composition.

17. The gas turbine engine component as recited in claim 16, wherein the gap does not exceed a width of 0.010″ (0.25 mm; 10 mils) with a surface erosion of less than about 0.04″ (1 mm; 40 mil).

18. The gas turbine engine component as recited in claim 16, further comprising means for melting and solution heat treating the Oxidation Resistant Braze (ORB) composition to form an alloy at least within the gap with a greater melting temperature than the Oxidation Resistant Braze (ORB) originally within the gap.

19. The gas turbine engine component as recited in claim 16, wherein the Oxidation Resistant Braze (ORB) composition has superior oxidation life than PWA 1455.

20. The gas turbine engine component as recited in claim 16, wherein the Oxidation Resistant Braze (ORB) composition has a superior oxidation life capability over PWA 1484.
